(19) United States
(12) Patent Application Publication
(10) Pub. No.: US 2022/0362714 A1
(43) Pub. Date: Nov. 17, 2022

(54) WATER RECYCLING APPARATUS

(71) Applicant: Sung-Fang TSAI, Taichung City (TW)

(72) Inventor: Sung-Fang TSAI, Taichung City (TW)

(21) Appl. No.: 17/721,280

(22) Filed: Apr. 14, 2022

(30) Foreign Application Priority Data
May 13, 2021 (TW) 110117317

(51) Int. Cl. B01D 61/08; B01D 61/02; C02F 1/00; C02F 1/44

(52) U.S. Cl. CPC B01D 61/08; B01D 61/025; C02F 1/006; C02F 1/441; B01D 2313/18; B01D 2313/12; C02F 2201/005

(57) ABSTRACT

A water recycling apparatus contains: a body, and inflow pipe, a reverse osmosis (RO) discharge pipe, and an outlet pipe. The body includes an accommodation chamber, a first receiving orifice, a second receiving orifice, and a third receiving orifice. The inflow pipe includes a first inlet, a first connection segment, and a first outlet. The RO discharge pipe includes a second inlet, a second connection segment, and a one-way check valve. The one-way check valve has a feeding segment and a discharging segment, such that the RO discharge pipe is connected with the feeding segment of the one-way check valve. The outlet pipe includes a guiding orifice, a third connection segment, and a leading orifice. The body further includes a first layer, a second layer, an inflatable layer, and an air nozzle communicating with the inflatable layer so as to inflate or deflate airs to the inflatable layer.

### FIELD OF THE INVENTION

The present invention relates to a water recycling apparatus by which running water and discharged water are mixed to produce recyclable water fed to the running water faucet, thus reusing the recyclable water, such as washing objects.

### BACKGROUND OF THE INVENTION

Earth suffers from a rare drought and lacks water everywhere. The water resources we have are not infinite, and water is one of the three essential elements for the survival of all natural biomass. Therefore, water plays an extremely important role in nature. It plays an important role, especially water is an indispensable element in human life, and especially the quality of drinking water is very important to the human body. However, with the changes of the times, economic development, and population increase, many areas are short of water sources. In some areas, drinking water sources are seriously polluted, and the safety of drinking water for residents is threatened. Or because the water pipes are old or the water towers do not have the habit of cleaning, the water pipes and water towers will also produce dirt after many years. The industry has developed a variety of water purification and filtration equipment, and the people have also purchased and installed them to filter drinking water to prevent polluted and unclean water from being drunk by the public. It is commonly used in water supply equipment so that water can be purified by reverse osmosis filtration, so as to achieve the effect of drinking water.

Nevertheless, the water filtration process of the reverse osmosis filter will discharge a large amount of discharge water, but in the case of lack of water resources, there is a risk of wasting water, and the amount of water wasted in the long run is considerable

The present invention has arisen to mitigate and/or obviate the afore-described disadvantages.

### SUMMARY OF THE INVENTION

The primary objective of the present invention is to provide a water recycling apparatus by which running water and discharged water are mixed to produce recyclable water fed to the running water faucet, thus reusing the recyclable water, such as washing objects.

To obtain the above mentioned objective, a water recycling apparatus provided by the present invention contains: a body, and inflow pipe, a reverse osmosis (RO) discharge pipe, and an outlet pipe.

The body includes an accommodation chamber defined in the body, a first receiving orifice, a second receiving orifice and a third receiving orifice which are all defined on a top of the body and communicating with the accommodation chamber.

The inflow pipe is connected with the first receiving orifice of the body, and the inflow pipe includes a first inlet defined on a top of the inflow pipe, a first connection segment extending around an outer rim of the first inlet, and a first outlet formed on a distal end of a bottom of the inflow pipe.

The reverse osmosis (RO) discharge pipe is connected with the second receiving orifice of the body, and the RO discharge pipe includes a second inlet defined in a top of the RO discharge pipe, a second connection segment extending around an outer rim of the second inlet, and a one-way check valve fixed on a distal end of a bottom of the RO discharge pipe. The one-way check valve has a feeding segment formed on a first end thereof and a discharging segment formed on a second end of the one-way check valve, such that the distal send of the bottom of the RO discharge pipe is connected with the feeding segment of the one-way check valve.

The outlet pipe is connected with the third receiving orifice of the body, and the outlet pipe includes a guiding orifice defined on a top of the outlet pipe, a third connection segment formed on an outer wall of the guiding orifice, and a leading orifice formed on a distal end of a bottom of the outlet pipe.

The body is made of flexible material, and the flexible material is plastic. The body includes a first layer, a second layer located inside the first layer, an inflatable layer defined between the first layer and the second layer, and an air nozzle arranged on an outer wall of the body and communicating with the inflatable layer so as to inflate or deflate airs to the inflatable layer.

The body is all-in-one modularized so as to be connected or detached easily. When running water flows into the body from the water supply tube via the inflow pipe, discharged water of the reverse osmosis filter RO flows into the body via the RO discharge pipe, such that the running water and the discharged water are mixed to produce recyclable water. Thereafter, the recyclable water is fed to the running water faucet to be reused by the body, for example, washing objects by using the recyclable water.

Furthermore, when the body is not inflated airs thereto, a size of the body is reduced so that the body is compact, thus storing the body easily.

### BRIEF DESCRIPTION OF THE DRAWINGS

FIG. 1 is a perspective view showing the assembly of a water recycling apparatus according to a first embodiment of the present invention.

FIG. 2 is a cross sectional view showing the assembly of the water recycling apparatus according to the first embodiment of the present invention.

FIG. 3 is a cross sectional view showing the application of the water recycling apparatus according to the first embodiment of the present invention.

FIG. 4 is a cross sectional view showing the assembly of a water recycling apparatus according to a second embodiment of the present invention.

FIG. 5 is a perspective view showing the assembly of a water recycling apparatus according to a third embodiment of the present invention.

FIG. 6 is a cross sectional view showing the assembly of the water recycling apparatus according to the third embodiment of the present invention.

FIG. 7 is a cross sectional view showing the application of the water recycling apparatus according to the third embodiment of the present invention.

FIG. 8 is a schematic view showing the application of the water recycling apparatus according to the present invention.

### DETAILED DESCRIPTION OF THE PREFERRED EMBODIMENTS

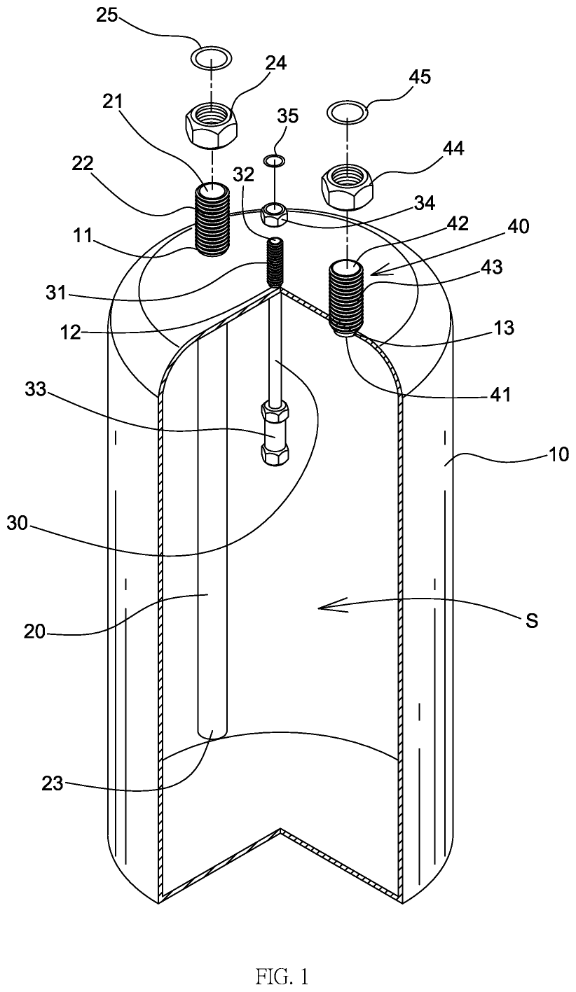

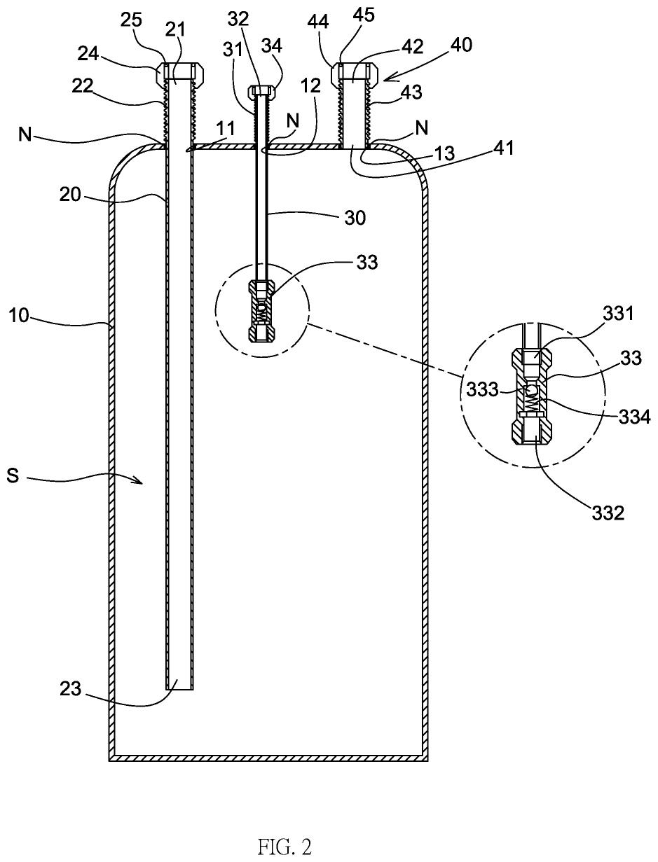

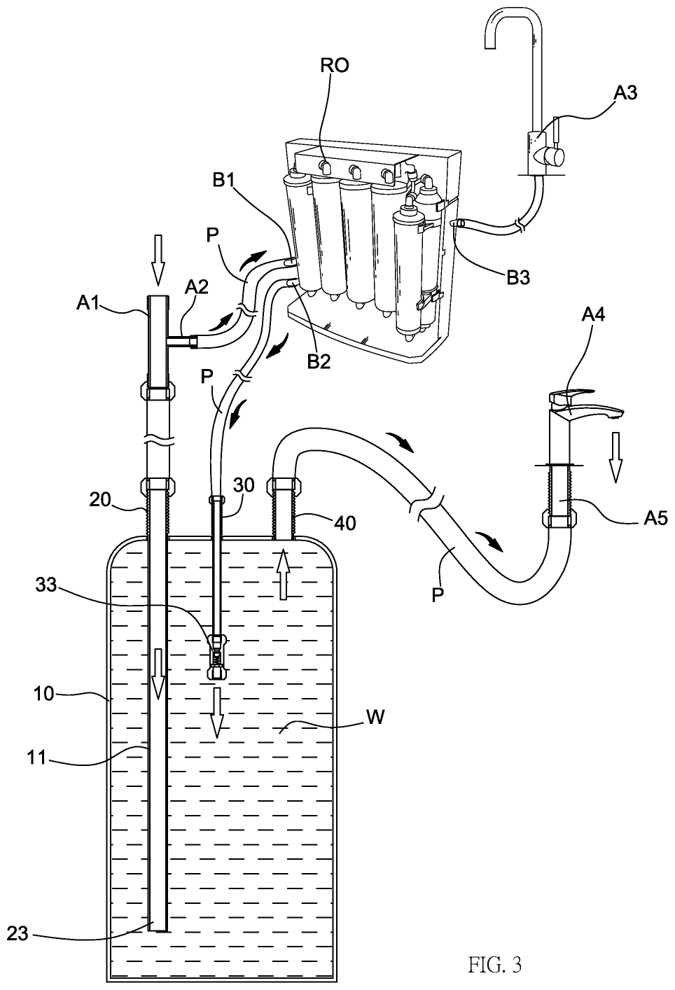

With reference to FIGS. 1-3, a water recycling apparatus according to a first embodiment of the present invention comprises:

a body 10 including an accommodation chamber S defined in the body 10, a first receiving orifice 11, a second receiving orifice 12 and a third receiving orifice 13 which are all defined on a top of the body 10 and communicate with the accommodation chamber S;

an inflow pipe 20 connected with the first receiving orifice 11 of the body 10, and the inflow pipe 20 including a first inlet 21 defined on a top of the inflow pipe 20, a first connection segment 22 extending around an outer rim of the first inlet 21, and a first outlet 23 formed on a distal end of a bottom of the inflow pipe 20;

a reverse osmosis (RO) discharge pipe 30 connected with the second receiving orifice 12 of the body 10, and the RO discharge pipe 30 including a second inlet 32 defined in a top of the RO discharge pipe 30, a second connection segment 31 extending around an outer rim of the second inlet 32, and a one-way check valve 33 fixed on a distal end of a bottom of the RO discharge pipe 30, wherein the one-way check valve 33 has a feeding segment 331 formed on a first end thereof and a discharging segment 332 formed on a second end of the one-way check valve 33, such that the distal send of the bottom of the RO discharge pipe 30 is connected with the feeding segment 331 of the one-way check valve 33, wherein the one-way check valve 33 has a ball 333 facing the feeding segment 331, a resilient element 334 received in the one-way check valve 33 opposite to the discharging segment 332 and pushed by the ball 333;

an outlet pipe 40 connected with the third receiving orifice 13 of the body 10, and the outlet pipe 40 including a guiding orifice 42 defined on a top of the outlet pipe 40, a third connection segment 43 formed on an outer wall of the guiding orifice 42, and a leading orifice 41 formed on a distal end of a bottom of the outlet pipe 40.

The first connection segment 22 of the inflow pipe 20 is movably connected with a first connector 24, and the inflow pipe 20 includes a first seal ring 25 fixed thereon with respect to the first connector 24. The third connection segment 31 of the RO discharge pipe 30 is movably connected with a second connector 34, and the RO discharge pipe 30 includes a second seal ring 35 fixed thereon with respect to the second connector 34, wherein the first inlet 21 of the inflow pipe 20 is connected with a water supply tube A1 by using the first connector 24 of the first connection segment 22, and the water supply tube A1 has a coupling tube A2 extending from an outer wall thereof and connected with a water feeding portion B1 of a first side of a reverse osmosis filter via a delivery tube P, wherein the reverse osmosis filter RO includes a discharge portion B2 arranged on the first side thereof, connected with the second connector 34 of the second connection segment 31 of the RO discharge pipe 30 via another delivery tube P, and communicating with the second inlet 32. The reverse osmosis filter RO further includes an output portion B3 extending from a second side thereof and having a water purification faucet A3 fixed on the output portion B3. The third connection segment 43 of the outlet pipe 40 is movably connected with a third connector 44, and the outlet pipe 40 includes a third seal ring 45 fixed thereon with respective to the third connector 44, wherein the third connection segment 43 of the outlet pipe 40 is coupled with a coupling tube A5 of a running water faucet A4 via the other delivery tube P.

A closing element N is mounted on a connection portion of the first receiving orifice 11 and the inflow pipe 20, another closing element N is mounted on a connection portion of the second receiving orifice 12 and the RO discharge pipe 30, and the other closing element N is mounted on a connection portion of the third receiving orifice 13 and the outlet pipe 40, wherein the three closing element N are a waterproof glue.

The body 10 is all-in-one modularized so as to be connected or detached easily. When running water flows into the body 10 from the water supply tube A1 via the inflow pipe 20, discharged water of the reverse osmosis filter RO flows into the body 10 via the RO discharge pipe 30, such that the running water and the discharged water are mixed to produce recyclable water W. Thereafter, the recyclable water W is fed to the running water faucet A4 to be reused by the body 10, for example, washing objects by using the recyclable water W.

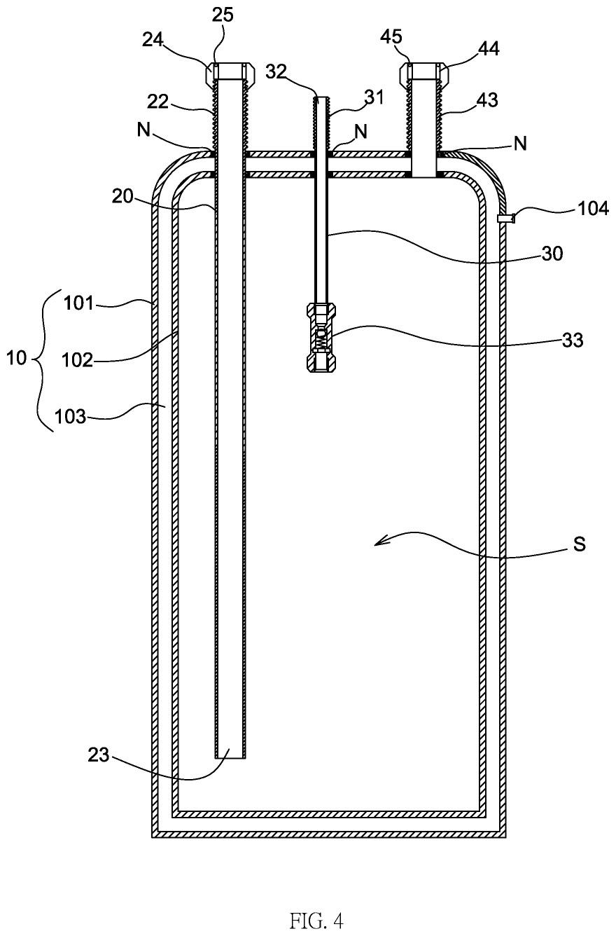

Referring to FIG. 4, in a second embodiment, the body 10 is made of flexible material, and the flexible material is plastic. The body 10 includes a first layer 101, a second layer 102 located inside the first layer 101, an inflatable layer 103 defined between the first layer 101 and the second layer 102, and an air nozzle 104 arranged on an outer wall of the body 10 and communicating with the inflatable layer 103 so as to inflate or deflate airs to the inflatable layer 103. When the body 10 is not inflated airs thereto, a size of the body 10 is reduced so that the body 10 is compact, thus storing the body 10 easily.

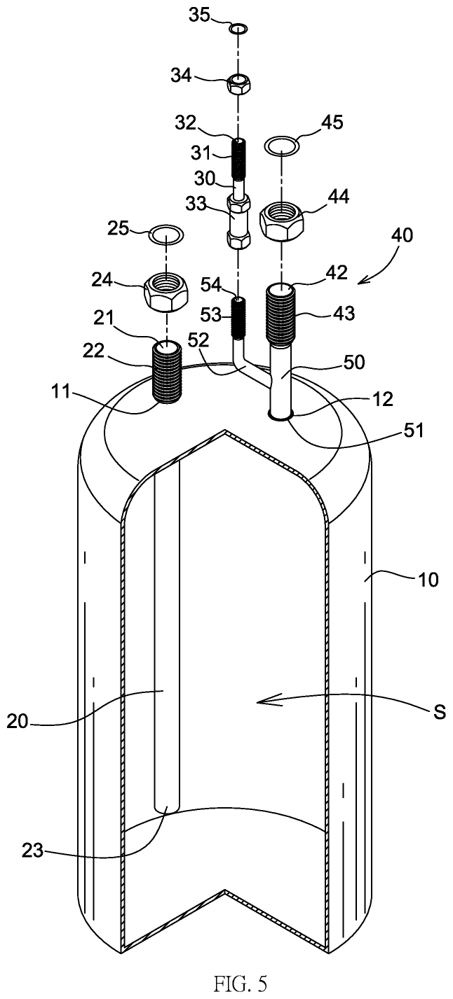

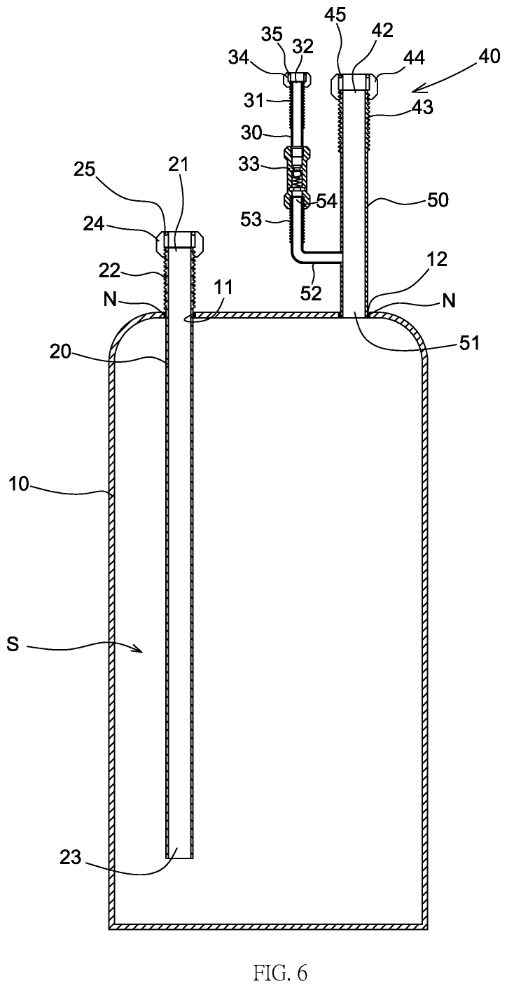

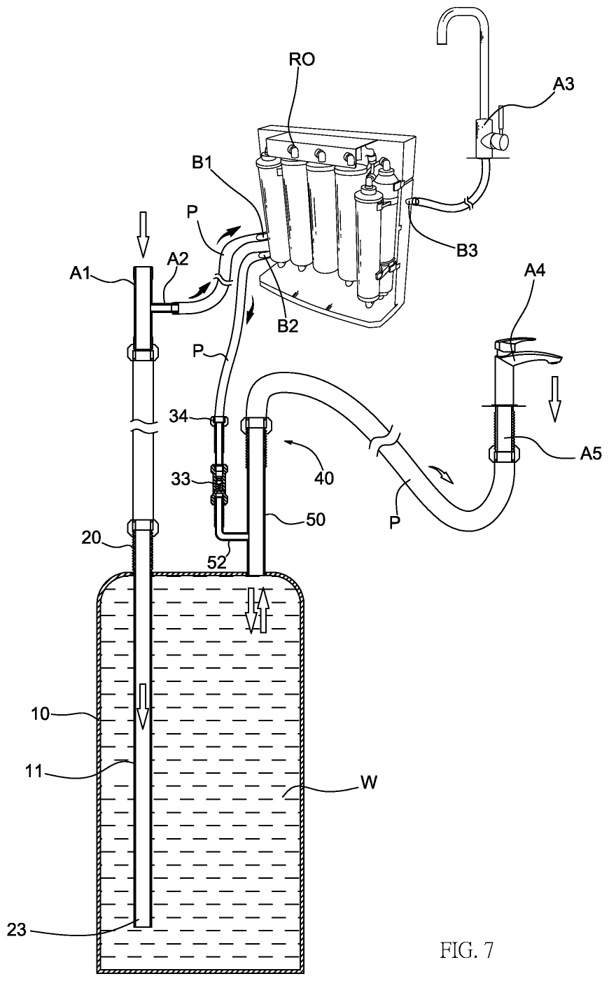

As shown in FIGS. 5-7, in a third embodiment, a T-shaped tube 50 is connected with the RO discharge pipe 30 and an outlet pipe 40. The water recycling apparatus comprises a body 10, ant the body 10 includes an accommodation chamber S defined therein, a first receiving orifice 11 and a second receiving orifice 12 which are both defined on a top of the body 10 and communicate with the accommodation chamber S. An inflow pipe 20 is connected with the first receiving orifice 11 of the body 10, and the inlet pipe 20 includes a first inlet 21 formed on a top thereof, a first connection segment 22 formed on an outer rim of the first inlet 21, and a first outlet 23 formed on a distal end of a bottom of the inflow pipe 20. The T-shaped tube 50 includes a fixing segment 51 formed on a bottom thereof and connected with the second receiving orifice 12 of the body 10, an auxiliary section 52 extending from the T-shaped tube 50, a locating segment 53 extending from a free end of the auxiliary section 52, and an exhaustion hole 54 defined in the locating segment 53.

A bottom of a RO discharge pipe 30 is connected with the exhaustion hole 54 of the auxiliary section 52 of the T-shaped tube 50. The RO discharge pipe 30 includes a second inlet 32 formed on a top thereof, a second connection segment 31 formed on an outer rim of the second inlet 32, and an one-way check valve 33 fixed on a distal end of a bottom of the RO discharge pipe 30, wherein the one-way check valve 33 has a feeding segment 331 formed on a first end thereof and a discharging segment 332 formed on a second end of the one-way check valve 33, such that the distal send of the bottom of the RO discharge pipe 30 is connected with the feeding segment 331 of the one-way check valve 33, wherein the fixing segment 51 of the T-shaped tube 50 is connected with the discharging segment 332 of the one-way check valve 33.

The outlet pipe 40 is connected with the top of the T-shaped tube 50, and the outlet pipe 40 includes a guiding orifice 42 defined on a top thereof.

The first connection segment 22 of the inflow pipe 20 is movably connected with a first connector 24, and the inflow pipe 20 includes a first seal ring 25 fixed thereon with respect to the first connector 24. The third connection segment 31 of the RO discharge pipe 30 is movably connected with a second connector 34, and the RO discharge pipe 30 includes a second seal ring 35 fixed thereon with respect to the second connector 34, wherein the third connection segment 43 of the outlet pipe 40 is movably connected with a third connector 44, and the outlet pipe 40 includes a third seal ring 45 fixed thereon with respective to the third connector 44, wherein a closing element N is mounted on a connection portion of the first receiving orifice 11 and the inflow pipe 20, and the other closing element N is mounted on a connection portion of the second receiving orifice 12 and the fixing segment 51 of the T-shaped tube 50, wherein the three closing element N are a waterproof glue. The one-way check valve 33 has a ball 333 facing the feeding segment 331, a resilient element 334 received in the one-way check valve 33 opposite to the discharging segment 332 and pushed by the ball 333.

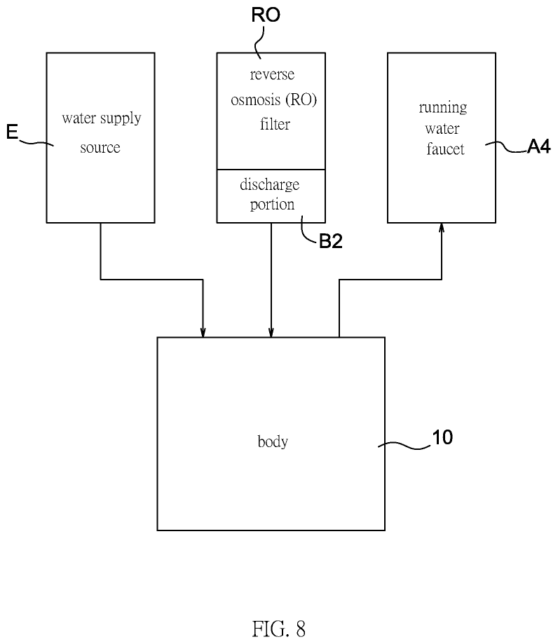

As shown in FIG. 8, the running water and the discharged water are fed into the body 10 from the water supply source and the reverse osmosis filter to produce the recyclable water and the recyclable water is delivered into a running water faucet.

When the running water faucet A4 is turned off, the recyclable water W is full of the body 10 completely and is discharged via the RO discharge pipe 30, wherein the recyclable water W flows into the RO discharge pipe 30 from the body 10 again via the first outlet 23 of the inflow pipe 20, the coupling tube A2 and a delivery tube P, thus reflowing the recyclable water W in the reverse osmosis filter RO to avoid overload of the recyclable water W in the body 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A water recycling apparatus comprising:
a body including an accommodation chamber defined in the body, a first receiving orifice, a second receiving orifice and a third receiving orifice which are all defined on a top of the body and communicating with the accommodation chamber;
an inflow pipe connected with the first receiving orifice of the body, and the inflow pipe including a first inlet defined on a top of the inflow pipe, a first connection segment extending around an outer rim of the first inlet, and a first outlet formed on a distal end of a bottom of the inflow pipe;
a reverse osmosis (RO) discharge pipe connected with the second receiving orifice of the body, and the RO discharge pipe including a second inlet defined in a top of the RO discharge pipe, a second connection segment extending around an outer rim of the second inlet, and a one-way check valve fixed on a distal end of a bottom of the RO discharge pipe, wherein the one-way check valve has a feeding segment formed on a first end thereof and a discharging segment formed on a second end of the one-way check valve, such that the distal send of the bottom of the RO discharge pipe is connected with the feeding segment of the one-way check valve;
an outlet pipe connected with the third receiving orifice of the body, and the outlet pipe including a guiding orifice defined on a top of the outlet pipe, a third connection segment formed on an outer wall of the guiding orifice, and a leading orifice formed on a distal end of a bottom of the outlet pipe;
wherein the body is made of flexible material, and the flexible material is plastic, the body includes a first layer, a second layer located inside the first layer, an inflatable layer defined between the first layer and the second layer, and an air nozzle arranged on an outer wall of the body and communicating with the inflatable layer so as to inflate or deflate airs to the inflatable layer.

2. The water recycling apparatus as claimed in claim 1, wherein the first connection segment of the inflow pipe is movably connected with a first connector, and the inflow pipe includes a first seal ring fixed thereon with respect to the first connector; the third connection segment of the RO discharge pipe is movably connected with a second connector, and the RO discharge pipe includes a second seal ring fixed thereon with respect to the second connector; the third connection segment of the outlet pipe is movably connected with a third connector, and the outlet pipe includes a third seal ring fixed thereon with respective to the third connector.

3. The water recycling apparatus as claimed in claim 1, wherein a closing element is mounted on a connection portion of the first receiving orifice and the inflow pipe, another closing element is mounted on a connection portion of the second receiving orifice and the RO discharge pipe, and the other closing element is mounted on a connection portion of the third receiving orifice and the outlet pipe, wherein the three closing element are a waterproof glue.

4. The water recycling apparatus as claimed in claim 1, wherein the one-way check valve has a ball facing the feeding segment, a resilient element received in the one-way check valve opposite to the discharging segment and pushed by the ball.

5. The water recycling apparatus as claimed in claim 1, wherein the first inlet of the inflow pipe is connected with a water supply tube by using the first connector of the first connection segment, and the water supply tube has a coupling tube extending from an outer wall thereof and connected with a water feeding portion of a first side of a reverse osmosis filter via one delivery tube, wherein the reverse osmosis filter includes a discharge portion arranged on the first side thereof, connected with the second connector of the second connection segment of the RO discharge pipe via another delivery tube, and communicating with the second inlet; and the third connection segment of the outlet pipe is coupled with a coupling tube of a running water faucet via the other delivery tube.
